(19) United States
(12) Patent Application Publication
(10) Pub. No.: US 2026/0367028 A1
(43) Pub. Date: Nov. 19, 2026

(54) DETECTING CHIP AND MANUFACTURING METHOD THEREOF

(71) Applicant: NAN YA PLASTICS CORPORATION, Taipei City (TW)

(72) Inventors: Ching-Yao Yuan, Taipei City (TW); Chun-Che Tsao, Taipei City (TW); Li-Yu Kao, Taipei City (TW)

(73) Assignee: NAN YA PLASTICS CORPORATION, Taipei City (TW)

(21) Appl. No.: 19/248,447

(22) Filed: Jun. 24, 2025

(30) Foreign Application Priority Data
May 14, 2025 (TW) 114118053

(51) Int. Cl. G01N 27/30

(52) U.S. Cl. CPC G01N 27/301

(57) ABSTRACT

A detecting chip is provided. The detecting chip includes a substrate and a detecting module disposed on the substrate. The detecting module includes a working electrode and a reference electrode. The working electrode is disposed on the substrate. The reference is disposed on the substrate and spaced apart from the working electrode. The reference electrode includes a conductive film, a reference electrode layer, a protective layer and a waterproof layer sequentially stacked on the substrate. A manufacturing method of a detecting chip is also provided.

### CROSS-REFERENCE TO RELATED APPLICATION

This application claims the priority benefit of Taiwan application serial no. 114118053, filed on May 14, 2025. The entirety of the above-mentioned patent application is hereby incorporated by reference herein and made a part of this specification.

### BACKGROUND

### Technical Field

The invention relates to a detecting chip, and particularly relates to a detecting chip and a manufacturing method thereof.

### Description of Related Art

Conventional detecting chips for solution property widely use silver/silver chloride (Ag/AgCl) reference electrodes. However, Ag/AgCl reference electrodes need to be immersed in standard solutions during storage, and their potential may be affected by ions in the sample solution, which makes them unable to measure potential stably for a long time, thereby affecting the stability and lifetime of the electrode. Therefore, there is an urgent need for a solution that can solve the above problems.

### SUMMARY

The invention provides a detecting chip and a manufacturing method thereof that may have good long-term stability and service lifetime of the electrode.

A detecting chip of the invention includes a substrate and a detecting module disposed on the substrate. The detecting module includes a working electrode and a reference electrode. The working electrode is disposed on the substrate. The reference electrode is disposed on the substrate and is spaced apart from the working electrode. The reference electrode includes a conductive film, a reference electrode layer, a protective layer and a waterproof layer sequentially stacked on the substrate.

In an embodiment of the invention, the reference electrode layer is disposed on the conductive film. The protective layer is disposed on the reference electrode layer and covers a sidewall of the reference electrode layer and a sidewall of the conductive film. The waterproof layer is disposed on the protective layer and covers a sidewall of the protective layer.

In an embodiment of the invention, a material of the protective layer includes a soluble salt, an acrylic copolymer resin, a surfactant, a solvent or a combination thereof.

In an embodiment of the invention, based on a total usage amount of the material of the protective layer being 100 parts by weight, a usage amount of the soluble salt is 10 parts by weight to 30 parts by weight, and/or a usage amount of the acrylic copolymer resin is 70 parts by weight to 90 parts by weight.

In an embodiment of the invention, a material of the waterproof layer includes polyethylene glycol, a siloxane-based polymer, a solvent or a combination thereof.

In an embodiment of the invention, based on a total usage amount of the material of the waterproof layer being 100 parts by weight, a usage amount of the polyethylene glycol is 10 parts by weight to 30 parts by weight, and/or a usage amount of the siloxane-based polymer is 70 parts by weight to 90 parts by weight.

In an embodiment of the invention, a material of the conductive film includes indium tin oxide. A material of the reference electrode layer includes silver chloride, carbon or gold.

In an embodiment of the invention, a thickness of the protective layer is 50 micrometers to 150 micrometers. A thickness of the waterproof layer is 5 micrometers to 50 micrometers.

In an embodiment of the invention, a plurality of detecting modules are disposed on the substrate. Each of the plurality of detecting modules respectively includes a working electrode and a corresponding reference electrode. The plurality of detecting modules are used for simultaneously detecting multiple different properties of a sample.

In an embodiment of the invention, the sample is a solution sample.

A manufacturing method of a detecting chip of the invention includes: providing a substrate; and disposing a detecting module on the substrate. The detecting module includes a working electrode and a reference electrode. The working electrode is disposed on the substrate. The reference electrode is disposed on the substrate and is spaced apart from the working electrode. The reference electrode includes a conductive film, a reference electrode layer, a protective layer and a waterproof layer sequentially stacked on the substrate.

Based on the above, in the detecting chip and the manufacturing method thereof of the invention, the reference electrode includes a reference electrode layer with a protective layer and a waterproof layer disposed thereon. Thus, the long-term stability and service lifetime of the electrode of the detecting chip are improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a top view schematic diagram of a detecting chip according to an embodiment of the invention.

FIG. 2 is a cross-sectional schematic diagram taken along section line A-A′ of FIG. 1.

### DESCRIPTION OF THE EMBODIMENTS

The invention is more comprehensively described with reference to the drawings of the present embodiment. However, the invention may also be embodied in various different forms and should not be limited to the embodiments described herein. The thickness of layers and regions in the drawings are exaggerated for clarity. The same or similar reference numbers indicate the same or similar elements, and the following paragraphs will not describe them repeatedly.

It should be understood that when an element such as an element is referred to as being “on” another element or “connected to” another element, it may be directly on the other element or connected to the other element, or intermediate elements may also be present. When an element is referred to as being “directly on another element” or “directly connected to” another element, no intermediate elements are present. As used herein, “connected” may refer to physical and/or electrical connection, while “electrically connected” or “coupled” may mean that other elements exist between two elements. “Electrically connected” as used herein may include physical connection (for example, wired connection) and physical disconnection (for example, wireless connection).

Furthermore, relative terms such as “below” or “bottom” and “above” or “top” may be used herein to describe the relationship of one element to another element, as shown in the drawings. It should be understood that the relative terms are intended to encompass different orientations of the device in addition to the orientation depicted in the drawings. For example, if the device in a drawing is turned over, elements described as being on the “lower” side of other elements would then be oriented on the “upper” side of the other elements. Thus, the exemplary term “below” may include both an orientation of “below” and “above,” depending on the particular orientation of the drawing. Similarly, if the device in a drawing is turned over, elements described as being “below” or “beneath” other elements would then be oriented to be “above” the other elements. Thus, the exemplary terms “above” or “below” may include both an orientation of above and below.

As used herein, “about,” “approximately,” or “substantially” include the stated value and average values within an acceptable deviation range of the particular value that can be determined by people having ordinary skills in the art, taking into consideration the particular amount of measurement discussed and errors associated with the measurement (i.e., limitations of the measurement system). For example, “about” may mean within one or more standard deviations of the stated value, or within +30%, +20%, +10%, +5%. Furthermore, “about,” “approximately,” or “substantially” as used herein may select a more acceptable deviation range or standard deviation according to optical properties, etching properties, or other properties, and may not use one standard deviation applicable to all properties.

Exemplary embodiments are described herein with reference to cross-sectional views that are schematic illustrations of idealized embodiments. Accordingly, variations of the shapes of the illustrations as a result of, for example, manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or non-linear features. Moreover, sharp angles that are illustrated may be rounded. Thus, the regions illustrated in the figures are schematic in nature and their shapes are not intended to illustrate the precise shape of a region and are not intended to limit the scope of the claims.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

The terminology used herein is for the purpose of describing exemplary embodiments only and is not intended to be limiting of the present disclosure. In this context, the singular forms include the plural forms unless the context clearly dictates otherwise.

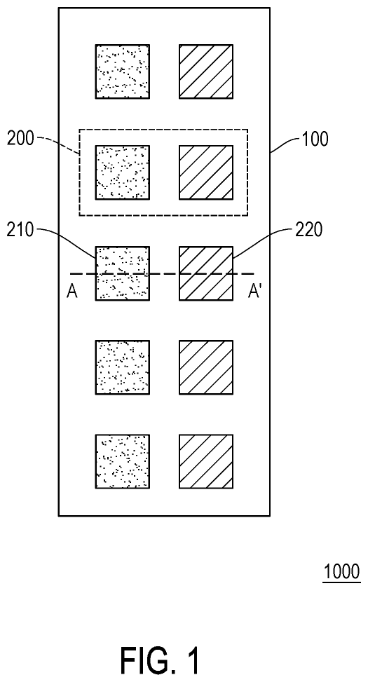

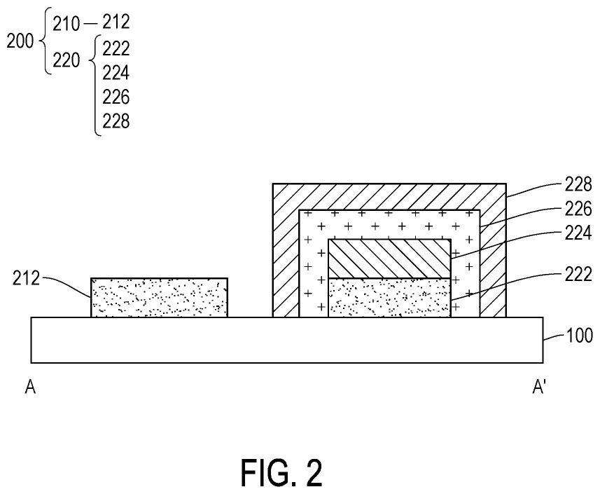

FIG. 1 is a top view schematic diagram of a detecting chip according to an embodiment of the invention. FIG. 2 is a cross-sectional schematic diagram taken along section line A-A′ of FIG. 1. In the top view schematic diagram of the present embodiment, some components in the cross-sectional schematic diagram are omitted to clearly illustrate the positional relationship between the components in the top view schematic diagram.

Please refer to FIG. 1 and FIG. 2, first, a substrate 100 is provided. In the present embodiment, the substrate 100 is, for example, a glass substrate. However, the invention is not limited thereto, and in other embodiments, the substrate 100 may also be a quartz substrate, a plastic substrate, or other suitable substrates.

Next, a detecting module 200 is disposed on the substrate 100. First, a conductive layer is formed on the substrate 100, wherein the conductive layer may be patterned to form a conductive film. For example, the conductive layer may be formed on the substrate 100 by means of the methods such as physical vapor deposition, chemical vapor deposition, sol-gel method or the like. The physical vapor deposition may include sputtering, electron beam evaporation, pulsed laser deposition, and other methods to perform thin film deposition. Then, the conductive layer may be performed to circuit etching and then patterned to form the conductive film. The conductive film may include a conductive film 212 for constituting a working electrode 210 and a conductive film 222 for constituting a reference electrode 220. A material of the conductive layer (i.e., a material of the conductive film) may include indium tin oxide (ITO), SnO₂, InO₂, ZnO or other suitable materials. The working electrode 210 including the conductive film 212 is disposed on the substrate 100 and is spaced apart from the reference electrode 220 disposed on the substrate 100.

Then, subsequent processing is performed on a portion of the conductive film, for example, the conductive film 222, such as sequentially stacking to form a reference electrode layer 224, a protective layer 226, and a waterproof layer 228 on the conductive film 222. For example, a material of the reference electrode layer 224 may first be formed on the conductive film 222 to form the reference electrode layer 224 by means of electrochemical method, screen printing method, and other process methods. The reference electrode layer 224 may be disposed on the conductive film 222. In the present embodiment, the reference electrode layer 224 does not cover a sidewall of the conductive film 222, but the invention is not limited thereto. The reference electrode layer 224 may cover the sidewall of the conductive film 222.

The material of the reference electrode layer 224 may include a material having the same anion as the soluble salt in a material of the protective layer 226 or other suitable materials. For example, when the material of the protective layer 226 includes potassium chloride (KCl), the material of the reference electrode layer 224 may include silver chloride (AgCl), carbon (C), gold (Au) or other suitable materials.

Next, the protective layer 226 is formed on the reference electrode layer 224. For example, the material of the protective layer 226 may be mixed and then homogenized to uniformly disperse each component to obtain a protective layer composition with improved stability and effect. Then, the homogenized protective layer composition may be coated on the reference electrode layer 224 by means of spin coating method, blade coating method, slot coating method, screen printing method or other suitable coating methods, and dried to form the protective layer 226 on the reference electrode layer 224 (i.e., the protective layer 226 formed by means of dry coating method). The protective layer 226 is disposed on the reference electrode layer 224 and may cover a sidewall of the reference electrode layer 224 and a sidewall of the conductive film 222. However, the invention is not limited thereto. The protective layer 226 may not cover the sidewall of the reference electrode layer 224 and the sidewall of the conductive film 222. In the present embodiment, the protective layer 226 may be an electrolyte layer. The protective layer 226 may be used to stabilize the potential of the reference electrode.

The material of the protective layer 226 may include a soluble salt, an acrylic copolymer resin, a surfactant, a solvent, a combination thereof or other suitable materials. The soluble salt may include potassium chloride, sodium chloride, lithium chloride, or other suitable soluble salts. The acrylic copolymer resin may include methyl methacrylate/butyl acrylate acrylic copolymer resin, methyl acrylate, butyl acrylate or other suitable acrylic copolymer resins. The surfactant may include a cationic surfactant, an anionic surfactant, a nonionic surfactant or other suitable surfactants. The solvent may include ethyl acetate, butanone or other suitable solvents. In the present embodiment, the material of the protective layer 226 includes a combination of the soluble salt and the acrylic copolymer resin, for example, a combination of potassium chloride and methyl methacrylate/butyl acrylate acrylic copolymer resin. Based on a total usage amount of the material of the protective layer 226 being 100 parts by weight, a usage amount of the soluble salt may be 10 parts by weight to 30 parts by weight, preferably 20 parts by weight to 25 parts by weight; a usage amount of the acrylic copolymer resin may be 70 parts by weight to 90 parts by weight, preferably 70 parts by weight to 75 parts by weight; a usage amount of the surfactant may be 0 parts by weight to 10 parts by weight, preferably 4 parts by weight to 6 parts by weight; a usage amount of the solvent may be 0 parts by weight to 15 parts by weight, preferably 5 parts by weight to 10 parts by weight. A thickness of the protective layer 226 may be 50 micrometers to 150 micrometers, preferably 70 micrometers to 80 micrometers.

Then, a waterproof layer 228 is formed on the protective layer 226. For example, a material of the waterproof layer 228 may be mixed uniformly to obtain a resin composition. The resin composition may be an aqueous resin composition, a non-aqueous solvent-based resin composition or a solvent-free resin composition. Subsequently, the resin composition may be coated on the protective layer 226 by means of spin coating method, blade coating method, slot coating method, screen printing method or other suitable coating methods, and then dried (i.e., dry coating method) or exposed to light to cure the resin composition into the waterproof layer 228 on the protective layer 226. The waterproof layer 228 is disposed on the protective layer 226 and may cover a sidewall of the protective layer 226. However, the invention is not limited thereto. The waterproof layer 228 may not cover the sidewall of the protective layer 226. The waterproof layer 228 may be used to stabilize the structure of the reference electrode, enabling the detecting module and the detecting chip including the same to have good stability, thereby improving their service lifetime.

The material of the waterproof layer 228 may include polyethylene glycol (PEG), siloxane-based polymer, a solvent, a combination thereof or other suitable materials. A weight average molecular weight of the polyethylene glycol may be 200,000 g/mol to 400,000 g/mol, preferably 250,000 g/mol to 300,000 g/mol. The siloxane-based polymer may include polydimethylsiloxane (PDMS) or other suitable siloxane-based polymers. A weight average molecular weight of the siloxane-based polymer may be 2,000 g/mol to 8,000 g/mol, preferably 4,000 g/mol to 6,000 g/mol. In the present embodiment, the material of the waterproof layer 228 may include a combination of polyethylene glycol and siloxane-based polymer, for example, a combination of polyethylene glycol (with a weight average molecular weight of about 300,000 g/mol) and polydimethylsiloxane (with a weight average molecular weight of about 5,000 g/mol). Based on a total usage amount of the material of the waterproof layer 228 being 100 parts by weight, a usage amount of polyethylene glycol may be 10 parts by weight to 30 parts by weight, preferably 15 parts by weight to 25 parts by weight, more preferably 17.5 parts by weight to 22.5 parts by weight; a usage amount of siloxane-based polymer may be 70 parts by weight to 90 parts by weight, preferably 75 parts by weight to 85 parts by weight, more preferably 77.5 parts by weight to 82.5 parts by weight; a usage amount of solvent may be 20 parts by weight to 30 parts by weight, preferably 20 parts by weight to 25 parts by weight. A thickness of the waterproof layer 228 may be 5 micrometers to 50 micrometers.

Based on the above, in the manufacturing method of the detecting chip 1000 according to an embodiment of the invention, a detecting module 200 may be disposed on the substrate 100, wherein the detecting module 200 includes a working electrode 210 and a reference electrode 220. The conductive film 222, the reference electrode layer 224, the protective layer 226, and the waterproof layer 228 sequentially stacked on the substrate 100 are disposed in the reference electrode 220, such that the waterproof layer 228 is used to stabilize the structure of the reference electrode 220, thereby enabling the detecting module 200 including the same and the detecting chip 1000 to have good stability to improve their service lifetime. For example, when a detecting chip not including a waterproof layer is immersed in a test solution (i.e., sample) for a long time, ions in the test solution may affect the ion concentration in the reference electrode, making the measured values of sample properties inaccurate. (For example, if the test solution contains chloride ions, they will affect the chloride ion concentration of the reference electrode layer in the reference electrode, causing the variation value of the measured sample properties to increase; or there may be interactions between the test solution and ions in the reference electrode, reducing the service lifetime of the reference electrode.) Compared to a detecting chip not including a waterproof layer, the detecting chip 1000 including the waterproof layer 228 may not be easily affected by ions in the test solution when immersed in the test solution for a long time. Thus, the measured values of sample properties and the service lifetime of the reference electrode may be improved.

In the present embodiment, a plurality of detecting modules 200 may be disposed on the substrate 100 of the detecting chip 1000 (as shown in FIG. 1). Each of the plurality of detecting modules 200 respectively includes a working electrode 210 and a reference electrode 220 corresponding to the working electrode 210. Thus, when the detecting chip 1000 is immersed in a test solution (i.e., sample), the plurality of detecting modules 200 may be used to simultaneously detect multiple different properties of the test solution (for example, pH value, conductivity, temperature, etc.). The sample may include blood, urine, reservoir water, aquaculture water, industrial water, etc., but is not limited thereto.

In the present embodiment, by means of the above method of forming the reference electrode layer 224, the protective layer 226, and the waterproof layer 228, detecting chips may be manufactured in large quantities, thereby reducing manufacturing costs.

In the following, the invention will be described in detail with reference to examples. The following examples are provided to describe the invention, and the scope of the invention includes the scope described in the following claims and substitutes and modifications thereof, and is not limited to the scope of the examples.

The following describes Example 1 to Example 3 and Comparative Example 1 of the detecting chip.

### Example 1 to Example 3

According to the content of Table 1, after the protective layer composition and the resin composition constituting the waterproof layer of each experimental example were respectively prepared, the protective layer composition was first applied on a glass substrate having an ITO conductive film and a silver chloride electrode layer (i.e., reference electrode layer) by means of screen printing, and dried to form an electrolyte composite layer (i.e., protective layer) with a thickness of 70 micrometers. Then, the resin composition was applied on the electrolyte composite layer by means of screen printing, and dried in an oven to form a waterproof layer with a thickness of 30 micrometers. The prepared detecting chips were measured for the time that their potential may be stably maintained in test solutions with different pH values, and the results are shown in Table 1.

### Comparative Example 1

A silver chloride electrode has no electrolyte layer and waterproof layer formed on the surface. The prepared detecting chips was measured for the time that their potential may be stably maintained in test solutions with different pH values, and the results are shown in Table 1.

TABLE 1

| Component | | | | | | Comparative |
|---|---|---|---|---|---|---|
| (unit: parts by weight) | | | Example 1 | Example 2 | Example 3 | Example 1 |
| Protective | | Potassium chloride | 30.00 | 20.00 | 10.00 | — |
| layer | | Acrylic | 70.00 | 80.00 | 90.00 | — |
| composition | | copolymer resin | | | | |
| Resin | | Polyethylene glycol | 20.00 | 20.00 | 20.00 | — |
| composition | | Polydimethylsiloxane | 80.00 | 80.00 | 80.00 | — |
| pH of | 4 | Time for which the | 5878 | 4003 | 1939 | 55 |
| Test | 7 | potential may be | 3026 | 2155 | 1090 | 30 |
| solution | 10 | stably maintained | 2094 | 1302 | 679 | 20 |
| | | (unit: hour) | | | | |

Acrylic copolymer resin: methyl methacrylate/butyl acrylate acrylic copolymer resin.

### <Evaluation Method>

At room temperature, each detecting chip was measured at different pH values using an electrochemical measurement system HZ7000 (model; manufactured by Meidensha Corporation), and observing how long the potential variation may be maintained within a range of less than 30 mV. When the time that the potential may be stably maintained is greater, it shows that the detecting chip may have good long-term stability and service lifetime of the electrode.

### <Evaluation Results>

As may be seen from Table 1, when the detecting chip includes a reference electrode having a protective layer and a waterproof layer disposed on a reference electrode layer (Example 1 to Example 3), the detecting chip may measure stable potential for a long time. That is, the detecting chip including a reference electrode having a protective layer and a waterproof layer disposed on the reference electrode layer may measure potential well and stably, and may have good long-term stability and service lifetime of the electrode.

Furthermore, when the detecting chip includes a reference electrode having no protective layer and waterproof layer disposed on the reference electrode layer (Comparative Example 1), the detecting chip may only measure stable potential for a short time. That is, the detecting chip including a reference electrode having no protective layer and waterproof layer disposed on the reference electrode layer cannot measure potential stably, and the long-term stability and service lifetime of the electrode may be poor.

Furthermore, the time that the potential may be stably maintained of the detecting chips including a reference electrode having a protective layer and a waterproof layer disposed on the reference electrode layer (Example 1 to Example 3) may be much greater than the time that the potential may be stably maintained of the detecting chip including a reference electrode having no protective layer and waterproof layer disposed on the reference electrode layer (Comparative Example 1). Therefore, compared to the detecting chip including a reference electrode having no protective layer and waterproof layer disposed on the reference electrode layer (Comparative Example 1), the detecting chips including a reference electrode having a protective layer and a waterproof layer disposed on the reference electrode layer (Example 1 to Example 3) have better and more stable potential measurement properties, as well as better long-term stability and service lifetime of the electrode.

Based on the above, when the detecting chip of the invention includes a reference electrode having a protective layer and a waterproof layer disposed on the reference electrode layer, the detecting chip may have good and stable potential measurement properties, as well as good long-term stability and service lifetime of the electrode, thereby having good applicability. Furthermore, since both the working electrode and the reference electrode in the detecting chip of the invention are dry electrodes, the detecting chip may not need to be immersed in a standard solution when the sample detection is not performed. Thus, compared to conventional detecting chips for solution property, the detecting chip of the invention is easier to store and has good applicability.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A detecting chip, comprising:
a substrate and a detecting module disposed on the substrate,
the detecting module comprising:
a working electrode disposed on the substrate; and
a reference electrode disposed on the substrate and spaced apart from the working electrode,
wherein the reference electrode comprises a conductive film, a reference electrode layer, a protective layer and a waterproof layer sequentially stacked on the substrate.

2. The detecting chip according to claim 1, wherein the reference electrode layer is disposed on the conductive film, the protective layer is disposed on the reference electrode layer and covers a sidewall of the reference electrode layer and a sidewall of the conductive film, the waterproof layer is disposed on the protective layer and covers a sidewall of the protective layer.

3. The detecting chip according to claim 1, wherein a material of the protective layer comprises a soluble salt, an acrylic copolymer resin, a surfactant, a solvent or combinations thereof.

4. The detecting chip according to claim 3, wherein based on a total usage amount of the material of the protective layer being 100 parts by weight, a usage amount of the soluble salt is 10 parts by weight to 30 parts by weight, and/or a usage amount of the acrylic copolymer resin is 70 parts by weight to 90 parts by weight.

5. The detecting chip according to claim 1, wherein a material of the waterproof layer comprises polyethylene glycol, a siloxane-based polymer, a solvent or a combination thereof.

6. The detecting chip according to claim 5, wherein based on a total usage amount of the material of the waterproof layer being 100 parts by weight, a usage amount of the polyethylene glycol is 10 parts by weight to 30 parts by weight, and/or a usage amount of the siloxane-based polymer is 70 parts by weight to 90 parts by weight.

7. The detecting chip according to claim 1, wherein a material of the conductive film comprises indium tin oxide, and/or a material of the reference electrode layer comprises silver chloride, carbon or gold.

8. The detecting chip according to claim 1, wherein a thickness of the protective layer is 50 micrometers to 150 micrometers, and/or a thickness of the waterproof layer is 5 micrometers to 50 micrometers.

9. The detecting chip according to claim 1, wherein a plurality of detecting modules are disposed on the substrate, each of the plurality of detecting modules respectively comprises a working electrode and a corresponding reference electrode,
the plurality of detecting modules are used for simultaneously detecting multiple different properties of a sample.

10. The detecting chip according to claim 9, wherein the sample is a solution sample.

11. A manufacturing method of a detecting chip, comprising:
providing a substrate; and
disposing a detecting module on the substrate, wherein the detecting module comprises:
a working electrode disposed on the substrate; and
a reference electrode disposed on the substrate and spaced apart from the working electrode,
wherein the reference electrode comprises a conductive film, a reference electrode layer, a protective layer and a waterproof layer sequentially stacked on the substrate.
